(19) United States
(12) Patent Application Publication
(10) Pub. No.: US 2006/0023470 A1
(43) Pub. Date: Feb. 2, 2006

(54) Impulse backlight system and a flat display using the same

(75) Inventors: Chun-Yuan Chen, Kaohsiung (TW); Chih-Kuang Chen, Kaohsiung City (TW); Hui-Kai Chou, Taipei City (TW); Yu-Chuan Lin, Kaohsiung (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: AU OPTRONICS CORPORATION, Hsinchu (TW)

(21) Appl. No.: 11/050,749

(22) Filed: Feb. 7, 2005

(30) Foreign Application Priority Data
Jul. 30, 2004 (TW) 93122966

(51) Int. Cl. F21V 7/04

(52) U.S. Cl. 362/611

(57) ABSTRACT

An impulse backlight system for a flat display is provided. The impulse backlight system includes flat light sources combined as a backlight area of the liquid crystal display to provide the flat display with luminosity, corresponding drivers for driving the flat light sources respectively and one or more inverters for providing the flat light sources with voltage power according to image display of the flat display.

### BACKGROUND OF THE INVENTION

1. Field of the Invention

The present invention relates to an impulse backlight system, and more particularly to an impulse backlight system of a flat display.

2. Description of the Related Art

Liquid crystal display (LCD) technology is one of most advanced and popular display technologies nowadays for computer monitors, communication products and consumer appliances. Contrary to the conventional display technology such as the cathode ray tube, the liquid crystal display technology utilizes a flat light source and a completely different image display principle which provide a flat-plate shape and much lighter weight. Liquid crystal display panel is provided with a backlight system for making the displayed information discernible. A backlight system may use fluorescent lamps, plasma lamps etc. FIG. 1A shows a conventional impulse backlight system using CCFLs. As shown in FIG. 1A, the conventional impulse backlight system includes two cold cathode fluorescent lamps 106 controlled by two drivers 104 respectively. The two drivers 104 are controlled by a controller 102. FIG. 1B shows another conventional impulse backlight system using a plasma lamp. The conventional impulse backlight system uses an inverter 112 and a driver 110 to control a plasma lamp 108.

Based on predetermined impulse signals, inverters of the backlight system supply driving voltage to the lamps. To be precise, this voltage supply is performed only in response to the on-periods of the pulse signals. FIGS. 2 and 3 show a structure of an LCD panel and waveform of lamp luminosity. As shown in FIG. 2, the LCD panel comprises a backlight system with six cold cathode fluorescent lamps (CCFLs) 206, thin-film transistor board 202 and color filter 204. FIG. 3 shows a waveform of lamp luminosity of the backlight system in FIG. 2, wherein one frame lasts for 17 ms and the lamps are turned on and off sequentially by a single main control unit (not shown).

The conventional LCD panel has been found disadvantageous in the following respect. First of all, for the LCD panel using the backlight systems shown in FIGS. 1A and 2, the relative long on/off responding time of cold cathode fluorescent lamp would drag the response of the LCD panel and decrease the quality of image. Secondly, the LCD panel with the lamps controlled by a single main control unit can only provide a limited image picture quality since the on/off sequence of the lamps are predetermined and unchangeable. In other words, the manner of controlling the lamps of the conventional backlight system does not dynamically respond to displaying various images needs.

### SUMMARY OF THE INVENTION

It is the objective of the present invention to provide a backlight system with multiple light sources and corresponding controllers.

It is the objective of the present invention to provide a backlight system with dynamic light source control and illumination responsive to displays of image.

In order to achieve the above objective of this invention, the present invention provides an impulse backlight system for a liquid crystal display. In one embodiment, the impulse backlight system comprises at least one flat light source as a backlight area of the liquid crystal display to provide the liquid crystal display with luminosity, at least one driver for driving the flat light sources, and at least one inverter for providing the flat light source with voltage power separately according to image display of the liquid crystal display. The numbers actually used of the flat light source, the driver and the inverter depend on the demand.

In another embodiment of the invention, the impulse backlight system comprises at least one flat light source as a backlight area of the liquid crystal display to provide the liquid crystal display with luminosity, at least one driver for driving the flat light sources, at least one inverter for providing the flat light source with voltage power according to image display of the liquid crystal display, and a light driving device having a controller for controlling and coordinating the inverters so as to turn on/off the flat light sources according to the signal from the light source driving device.

### BRIEF DESCRIPTION OF THE DRAWINGS

The objectives and features of the present invention as well as advantages thereof will become apparent from the following detailed description, considered in conjunction with the accompanying drawings.

FIG. 1A shows a conventional impulse backlight system using CCFLs;

FIG. 1B shows a conventional impulse backlight system using a plasma lamp;

FIG. 2 shows a structure of a conventional LCD panel using CCFLs;

FIG. 3 shows a waveform of lamp luminosity of the LCD panel shown in FIG. 2;

FIGS. 4A-4B, 5 and 6A-6B show embodiments of the backlight system of the invention;

FIG. 7A shows a relation between a single flat lamp and a backlight area;

FIG. 7B shows one embodiment of the arrangement of the flat lamps; and

FIG. 7C shows another embodiment of the arrangement of the flat lamps.

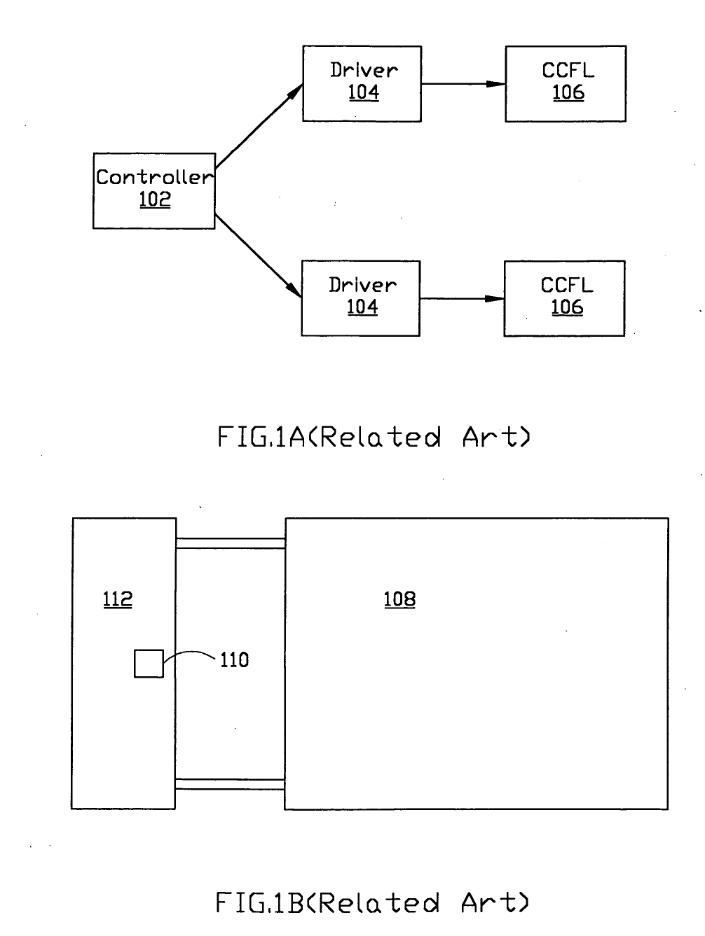

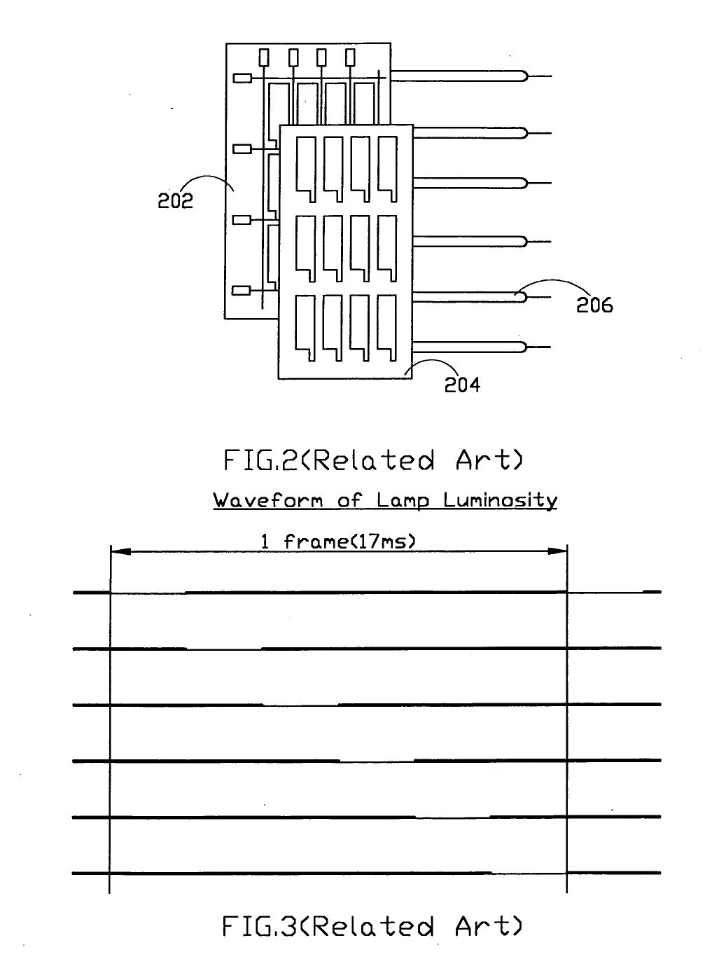

### DESCRIPTION OF THE PREFERRED EMBODIMENTS

It is to be understood and appreciated that the structures described below do not cover a complete structure. The present invention can be practiced in conjunction with various fabrication techniques that are used in the art, and only so much of the commonly elements are included herein as are necessary to provide an understanding of the present invention.

A flat display such as a liquid crystal display module includes a display unit having a liquid crystal display panel for showing the images. The display unit basically includes a liquid crystal display panel, an integrated circuit board. The liquid crystal display panel includes a thin film transistor board, a color filter board and liquid crystal disposed between the thin film transistor board and the color filter board. The thin film transistor board is a transparent glass on which the thin film transistors are formed in matrix. Data lines are respectively connected with source terminals of the thin film transistors and gate lines connected with gate terminals of the thin film transistors. Furthermore, pixel electrodes respectively and electrically connect to drain terminals of the thin film transistors, which are made of a transparent conductive material such as Indium Tin Oxide (ITO).

As being inputted to the data lines and the gate lines, the electric signals are applied to the source terminals and the gate terminals of each thin film transistor of the thin film transistor board to turn on or turn off the thin film transistors according to an input of electricity, resulting in outputting the electric signals required to form pixels.

The color filter board is disposed to face to the thin film transistor board in the display unit. RGB pixels are formed on the color film board by means of a thin film process, which present a predetermined color while the light passes through the color film board. Common electrodes made of Indium Tin Oxide are coated on the front surface of the color film board. The color filter board has a compensatory film and a polarizing plate formed on an upper portion to improve a visual field angle.

When the thin film transistors are turned on by applying electricity to the gate terminals and the source terminals of the thin film transistors, electric field is created between the pixel electrodes of the thin film transistor board and the common electrodes of the color filter board. The electric field makes the liquid crystal, which is injected in a space between the thin film transistor board and the color filter board, to change the array angle thereof, resulting in that the permeability of the light is changed. As a result, it is possible to gain the desired pixels.

Meanwhile, a driving signal and a timing signal are applied to the gate lines and data lines of the thin film transistors in order to control the array angle of the liquid crystal and the time of arraying the liquid crystal in the liquid crystal display panel. The integrated circuit boards applies the driving signal to the gate line and the data line as soon as receiving image signals inputted from outside of the liquid crystal display panel. The integrated circuit board receives the image signals provided from an information process device such as a computer and the like and generates the gate driving signal and the data signal for operating the liquid crystal display device and a plurality of timing signals for applying the gate driving signal and the data signal to the gate lines and the data lines of the liquid crystal display panel.

A backlight system is disposed under the display unit to supply the light to the display unit uniformly. The backlight system includes lamps for generating the light. A light guide plate has a size corresponding to that of the liquid crystal display panel of the display unit. The light guide plate is disposed under the liquid crystal display panel so as to guide the light generated by the lamp to the display unit while changing the pathway of the light.

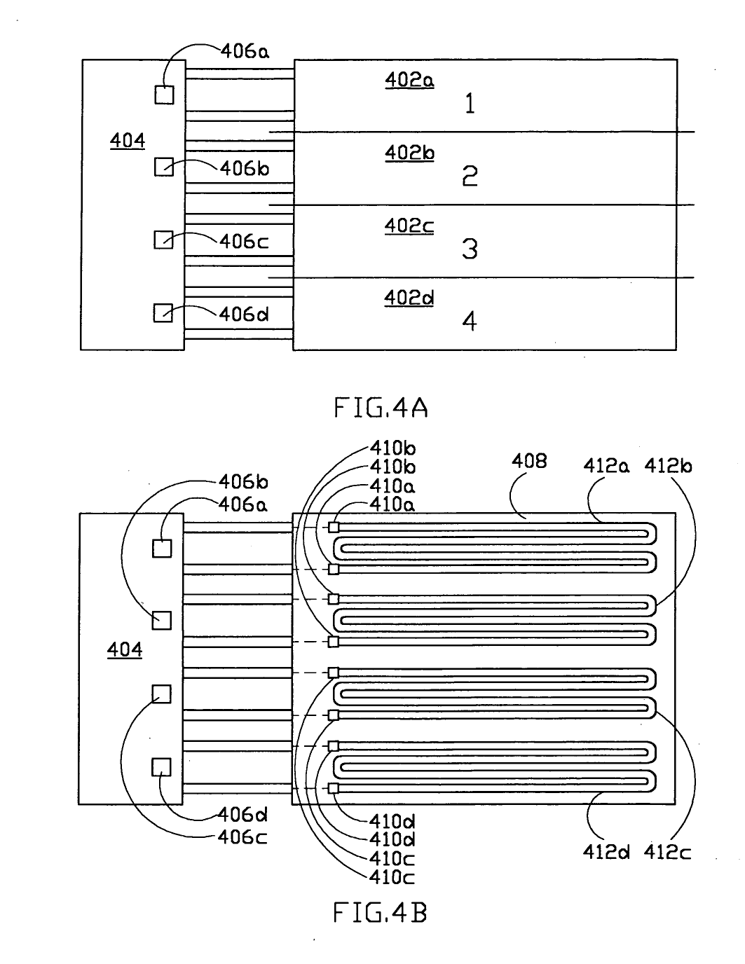

In one embodiment of the invention, a backlight system with multiple light sources each having a corresponding driver is provided. FIG. 4A shows a backlight system having four flat lamps 402a, 402b, 402c and 402d comprising plasma lamps controlled by an inverter 404 and corresponding drivers 406a, 406b, 406c and 406d. The inverter 404 is coupled to the drivers 406a, 406b, 406c and 406d. The backlight system in this embodiment uses four identical flat lamps 402a, 402b, 402c and 402d to provide an LCD panel with lamp luminosity. The flat lamps 402a, 402b, 402c and 402d are controlled by the drivers 406a, 406b, 406c and 406d respectively. The inverter 404 supplies a driving voltage to the flat lamps 402a, 402b, 402c and 402d but the flat lamps 402a, 402b, 402c and 402d are turned on/off by the drivers 406a, 406b, 406c and 406d. The flat lamps 402a, 402b, 402c and 402d can be controlled to provide lamp luminosity independently. That is, the backlight area of an LCD panel can be divided into four blocks, which are illuminated separately. By using the backlight system, the LCD panel can have dynamic lamp luminosity coordinating the image display thereof. The backlight system provides individual and arbitrary block or area control of lamp luminosity contrary to the conventional backlight system.

FIG. 4B shows another embodiment of the backlight system having a flat light source assembly 408 controlled by the inverter 404 and corresponding drivers 406a, 406b, 406c and 406d. The flat light source assembly 408 comprises four flat lamps controlled by the drivers 406a, 406b, 406c and 406d respectively to provide an LCD panel with lamp luminosity. The flat lamps are covered by a common upper transparent substrate and a common bottom transparent substrate. The flat lamps comprise serpentine cold cathode fluorescent flat lamps 412a, 412b, 412c and 412d with electrodes 410a, 410b, 410c and 410d respectively. Comparing to the four flat lamps 402a, 402b, 402c and 402d shown in FIG. 4A, the flat light source assembly 408 including the serpentine cold cathode fluorescent lamps 412a, 412b, 412c and 412d which can be controlled respectively uses common upper and bottom transparent substrates and the appearance thereof is similar to a single flat light source. However, the serpentine cold cathode fluorescent lamps 412a, 412b, 412c and 412d can also be controlled independently and the backlight area of a LCD panel can be divided into four blocks which are illuminated separately, just like the flat lamps 402a, 402b, 402c and 402d in FIG. 4A.

The backlight system in FIGS. 4A and 4B are only examples, not limitations. As shown in FIG. 5, another backlight system with an arrangement of flat lamps different to the backlight system in FIG. 4. The backlight area of an LCD panel can be divided into four blocks, which are provided with lamp luminosity separately. As shown in FIG. 5, the backlight system includes four flat lamps 502a, 502b, 502c and 502d comprising plasma lamps and serpentine cold cathode fluorescent lamps controlled by an inverter and corresponding drivers 506a, 506b, 506c and 506d. The inverter (not shown) is coupled to the drivers 506a, 506b, 506c and 506d. The flat lamps 502a, 502b, 502c and 502d are controlled by the drivers 506a, 506b, 506c and 506d located at the four corners of the backlight system respectively. The drivers 506a, 506b, 506c and 506d turn on/off the flat lamp 502a 502b, 502c and 502d respectively to provide the corresponding blocks of the backlight area with lamp luminosity according to the image display of the LCD panel.

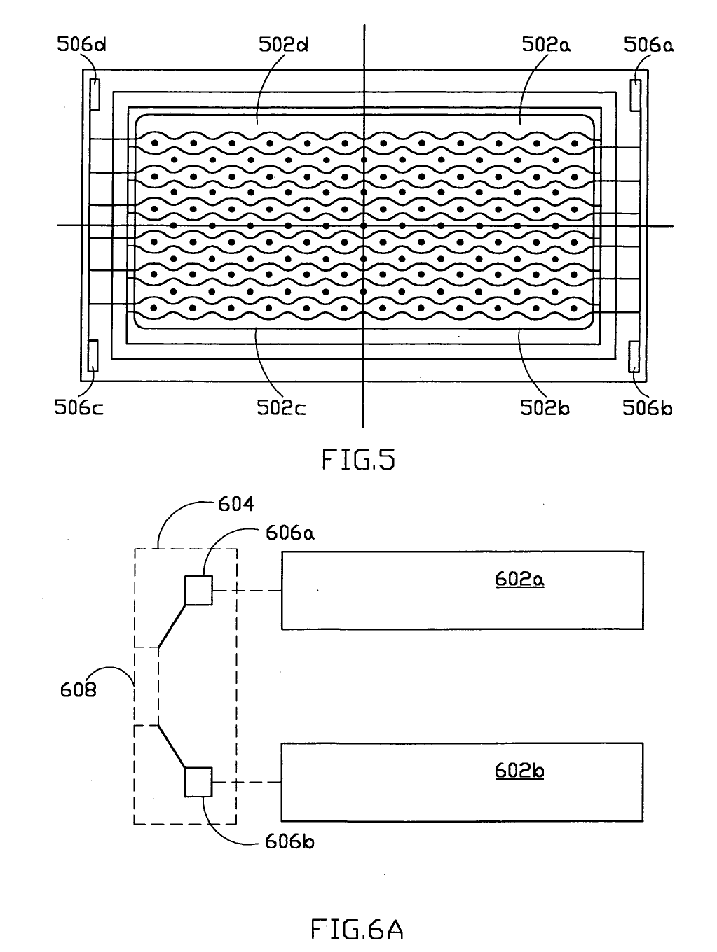

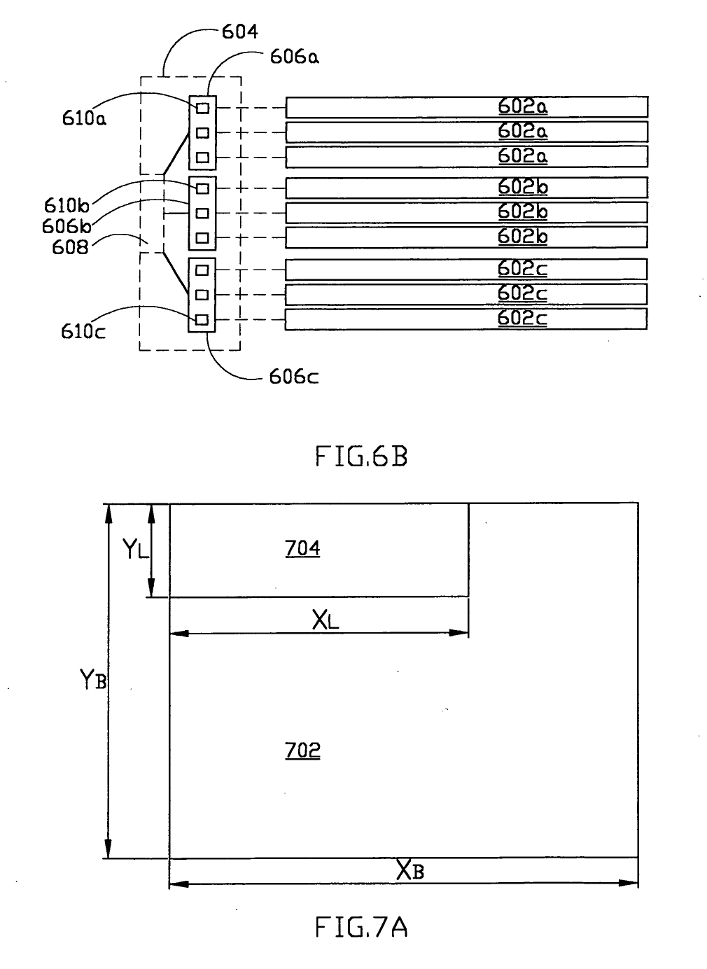

In another embodiment of the invention, a light driving device is provided to coordinate multiple light sources of a backlight system. As shown in FIG. 6A, a light driving device 604 having a controller 608 to control inverters 606a and 606b and two flat lamps 602a and 602b. The light driving device 604 controls the flat lamps 602a and 602b according to the arraying of the liquid crystal of an LCD panel. The controller 608 coordinates the inverters 606a and 606b so as to turn on/off the flat lamps 602a and 602b according to the signal from the light driving device 604. The light driving device 604 receives signal from an integrated circuit board which receives the image signals provided from an information process device such as a computer and the like.

FIG. 6B shows another embodiment of the backlight system. The backlight system uses a controller 608 comprising a controller 608 of the light driving device 604 to control inverters 606a, 606b and 606c. The inverters 606a, 606b and 606c utilize drivers 610a, 610b and 610c to control the flat lamps 602a, 602b and 602c according to the arraying of the liquid crystal of an LCD panel respectively. The inverters 606a, 606b and 606c are coupled to the drivers 610a, 610b and 610c respectively. The controller 608 coordinates the inverters 606a, 606b and 606c so as to turn on/off the flat lamps 602a, 602b and 602c according to the signal from the light driving device 604.

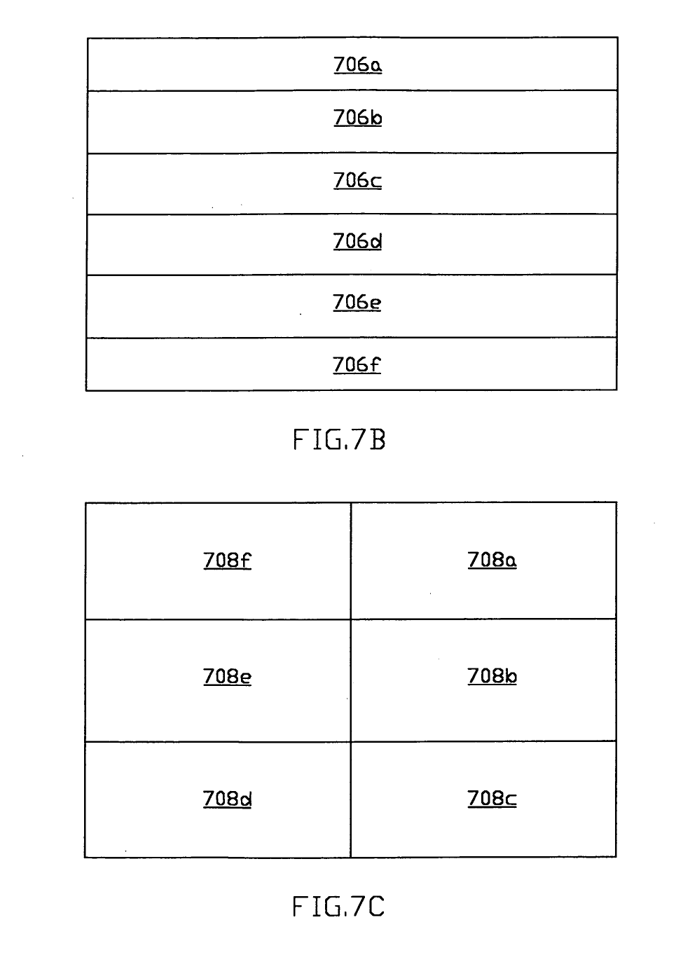

It is noted that the arrangement of the flat lamps mentioned above is only an example, not a limitation. The flat lamps can be arranged in the following embodiments. FIG. 7A shows a relation between a single flat lamp 704 and a backlight area 702. The backlight area 702 comprises a rectangular shape, and X_{B} and X_{L} are the sizes of the backlight area and the lamp along x axis, Y_{B} and Y_{L} are the sizes of the backlight area and the lamp along y axis. Preferably, the relation between the flat lamp 704 and the backlight area 702 is Y_{B}/Y_{L}≧2, X_{B}/X_{L}≧1. FIG. 7B shows one embodiment of the arrangement of the flat lamps including flat lamps 706a, 706b, 706c, 706d, 706e and 706f similar to the backlight system shown in FIG. 4A. FIG. 7C shows another embodiment of the arrangement of the flat lamps including flat lamps 708a, 708b, 708c, 708d, 708e and 708f similar to the backlight system shown in FIG. 5. It is noted that although the embodiments of the invention only provide applications of backlight system on liquid crystal displays, the backlight system of the invention should not be limited to be applied to any other flat displays.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. An impulse backlight system for a flat display, comprising:
a flat light source;
a driver for driving said flat light source; and
an inverter for supplying a driving voltage to said flat light source;
wherein a rectangular backlight area is defined by said flat light source, the lengths of said flat light source and said rectangular backlight area along x axis are X_{L} and X_{B} respectively, and the lengths of said flat light source and said rectangular backlight area along y axis are Y_{L} and Y_{B} respectively, wherein Y_{B}/Y_{L} is greater than or equal to 2 and X_{B}/X_{L} is greater than or equal to 1.

2. The impulse backlight system according to claim 1, wherein said flat light source comprises a plasma lamp.

3. The impulse backlight system according to claim 1, wherein said flat light source comprises a serpentine cold cathode fluorescent lamp.

4. The impulse backlight system according to claim 1, further comprising an upper transparent substrate and a lower transparent substrate, wherein the flat light source is disposed between the upper transparent substrate and the lower transparent substrate.

5. The impulse backlight system according to claim 1 further comprising:
a light driving device having a controller, wherein the controller is for controlling the inverter; and
an integrated circuit board for controlling the controller.

6. The impulse backlight system according to claim 5, further comprising an information process device, wherein said integrated circuit board is for receiving image signals from the information process device.

7. A flat panel display comprising:
a display panel; and
an impulse backlight system disposed under said display panel, said impulse backlight system comprising:
a flat light source;
a driver for driving said flat light source; and
an inventor for supplying a driving voltage to said flat light source;
wherein a rectangular backlight area is defined by said flat light source, the lengths of said flat light source and said rectangular backlight area along x axis are X_{L} and X_{B} respectively, and the lengths of said flat light source and said rectangular backlight area along y axis are Y_{L} and Y_{B} respectively, wherein Y_{B}/Y_{L} is greater than or equal to 2 and X_{B}/X_{L} is greater than or equal to 1.

8. The flat panel display according to claim 7, wherein said flat panel display is a liquid crystal display.

9. The flat panel display according to claim 7, wherein said flat light source comprises a plasma lamp.

10. The flat panel display according to claim 7, wherein said flat light source comprises a serpentine cold cathode fluorescent lamp.

11. The flat panel display according to claim 7, further comprising an upper transparent substrate and a lower transparent substrate, wherein the flat light source is disposed between the upper transparent substrate and the lower transparent substrate.

12. The flat panel display according to claim 7, further comprising:
a light driving device having a controller for controlling the inverter; and
an integrated circuit board for controlling the controller.

13. The flat panel display according to claim 12, further comprising an information process device, wherein said integrated circuit board is for receiving image signals from the information process device.

14. An impulse backlight system for a flat display apparatus, said impulse backlight system comprising:
a plurality of flat light sources;
a plurality of drivers, wherein each of the plurality of drivers is coupled to each of the plurality of flat light sources; and
an inverter coupled to the plurality of drivers, wherein the inverter supplies a driving voltage to the plurality of flat light sources.

15. The impulse backlight system according to claim 14, wherein a rectangular backlight area is defined by said flat light source, wherein the lengths of said flat light source and said rectangular backlight area along x axis are X_{L} and X_{B} respectively and the lengths of said flat light source and said rectangular backlight area along y axis are Y_{L} and Y_{B} respectively, wherein Y_{B}/Y_{L} is greater than or equal to 2 and X_{B}/X_{L} is greater than or equal to 1.

16. The impulse backlight system according to claim 14, wherein each of the plurality of flat light sources comprises a plasma lamp.

17. The impulse backlight system according to claim 14, wherein each of the plurality of flat light sources comprises a serpentine cold cathode fluorescent lamp.

18. The impulse backlight system according to claim 14, further comprising:
a light driving device having a controller coupled to said inverter; and
an integrated circuit board coupled to the controller.

19. The impulse backlight system according to claim 18, further comprising an information process device, wherein said integrated circuit board is coupled to the information process device.
